(19) United States
(12) Patent Application Publication
(10) Pub. No.: US 2012/0249755 A1
(43) Pub. Date: Oct. 4, 2012

(54) PICTURE PRESENTATION SYSTEM

(76) Inventor: Tetsuro NARIKAWA, Hamura-shi (JP)

(21) Appl. No.: 13/434,483

(22) Filed: Mar. 29, 2012

(30) Foreign Application Priority Data
Mar. 30, 2011 (JP) 2011-076201

(51) Int. Cl. H04N 13/04

(52) U.S. Cl. 348/51; 348/E13.075; 348/E13.036

(57) ABSTRACT

A picture presentation system includes a first shutter device, a second shutter device, and a picture presentation device. The picture presentation device includes a picture presentation unit configured to present a first picture and a second picture in sequence, a first control signal transmitting unit configured to transmit the first control signal to bring the first shutter and the second shutter into a closed state when the second picture is presented, and a second control signal transmitting unit configured to transmit the second control signal to bring at least one of the third shutter and the fourth shutter into an opened state when the second picture is presented.

### CROSS-REFERENCE TO RELATED APPLICATIONS

This application is based upon and claims the benefit of priority under 35 USC 119 of Japanese Patent Application No. 2011-076201 filed Mar. 30, 2011, the entire disclosure of which, including the description, claims, drawings, and abstract, is incorporated herein by reference in its entirety.

### BACKGROUND OF THE INVENTION

1. Field of the Invention

The present invention relates to a picture presentation system configured to display different pictures depending on the users.

2. Description of the Related Art

At present, a television set configured to show a three-dimensional picture to the user by alternately showing a left-eye picture, and right-eye picture respectively to the left eye, and right eye of the user by using a liquid-crystal shutter or a polarizing filter is commercialized (for example, Jpn. Pat. Appln. KOKAI Publication No. 2006-250999).

Under these circumstances, there is a demand that a picture to be viewed be different depending on the users.

### BRIEF SUMMARY OF THE INVENTION

Accordingly, it is an object of the present invention to provide a picture presentation system capable of making a picture to be viewed different depending on the users.

According to one aspect of the present invention, there is provided a picture presentation system comprising: a first shutter device that includes: a first shutter corresponding to one eye of a first user, a second shutter corresponding to the other eye of the first user, a first receiving unit configured to receive a first control signal used to control opening/closing of the first shutter and the second shutter, and a first control unit configured to control opening/closing of the first shutter and the second shutter on the basis of the first control signal; a second shutter device that includes: a third shutter corresponding to one eye of a second user, a fourth shutter corresponding to the other eye of the second user, a second receiving unit configured to receive a second control signal used to control opening/closing of the third shutter and the fourth shutter, and a second control unit configured to control opening/closing of the third shutter and the fourth shutter on the basis of the second control signal; and a picture presentation device that includes: a picture presentation unit configured to present a first picture and a second picture in sequence, a first control signal transmitting unit configured to transmit the first control signal to bring the first shutter and the second shutter into a closed state when the second picture is presented, and a second control signal transmitting unit configured to transmit the second control signal to bring at least one of the third shutter and the fourth shutter into an opened state when the second picture is presented.

According to the present invention, it is possible to make a picture to be viewed different depending on the users.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of a picture presentation system according to a first embodiment of the present invention;

FIG. 2 is a block diagram showing the configuration of the first spectacles shown in FIG. 1;

FIG. 3 is a block diagram showing the configuration of the second spectacles shown in FIG. 1;

FIG. 4 is a view for explaining a picture displayed on a screen on the basis of picture data reproduced by a reproduction device shown in FIG. 1;

FIG. 5 is a view showing a left-eye picture displayed on the screen on the basis of picture data;

FIG. 6 is a view showing a right-eye picture displayed on the screen on the basis of picture data;

FIG. 7 is a view showing an auxiliary picture displayed on the screen on the basis of picture data;

FIG. 8 is a view showing a picture to be presented to a user wearing the first spectacles;

FIG. 9 is a view showing a picture to be presented to a user wearing the second spectacles;

FIG. 10 is a view showing the opening/closing timing of each of the first left-eye liquid-crystal shutter, first right-eye liquid-crystal shutter, second left-eye liquid-crystal shutter, and second right-eye liquid-crystal shutter for the projection timing of a left-eye optical image, right-eye optical image, and auxiliary optical image;

FIG. 11 is a view for explaining an optical image formed by a micromirror element on the basis of picture data;

FIG. 12 is a view showing a first auxiliary picture displayed on the screen by a first auxiliary optical image;

FIG. 13 is a view showing a second auxiliary picture displayed on the screen by a second auxiliary optical image;

FIG. 14 is a view showing a picture viewed by the user wearing the first spectacles;

FIG. 15 is a view showing a picture viewed by the user wearing the second spectacles;

FIG. 16 is a view showing the opening/closing timing of each of the first left-eye liquid-crystal shutter, first right-eye liquid-crystal shutter, second left-eye liquid-crystal shutter, and second right-eye liquid-crystal shutter for the projection timing of a left-eye optical image, right-eye optical image, first auxiliary optical image, and second auxiliary optical image;

FIG. 17 is a block diagram showing the configuration of a picture presentation system according to a second modification example of the first embodiment of the present invention;

FIG. 18 is a block diagram showing the configuration of the third spectacles shown in FIG. 17;

FIG. 19 is a view showing the opening/closing timing of each of the first left-eye liquid-crystal shutter, first right-eye liquid-crystal shutter, second left-eye liquid-crystal shutter, second right-eye liquid-crystal shutter, third left-eye liquid-crystal shutter, and third right-eye liquid-crystal shutter for the projection timing of a left-eye optical image, right-eye optical image, first auxiliary optical image, and second auxiliary optical image;

FIG. 20 is a block diagram showing the configuration of a picture presentation system according to a third modification example of the first embodiment of the present invention;

FIG. 21 is a block diagram showing the configuration of a picture presentation system according to a second embodiment of the present invention;

FIG. 22 is a view for explaining a picture displayed on a screen on the basis of picture data;

FIG. 23 is a view showing a first picture displayed on the screen on the basis of picture data;

FIG. 24 is a view showing a second picture displayed on the screen on the basis of picture data;

FIG. 25 is a block diagram showing the configuration of the spectacles shown in FIG. 21;

FIG. 26 is a view showing the opening/closing timing of the liquid-crystal shutters for the formation timing of the first optical image and second optical image in a case where a ratio of the display time of the first picture to the display time of the second picture is 100:0;

FIG. 27 is a view showing the opening/closing timing of the liquid-crystal shutters for the formation timing of the first optical image and second optical image in a case where a ratio of the display time of the first picture to the display time of the second picture is 75:25;

FIG. 28 is view showing a picture viewed by the user in a case where a ratio of the display time of the first picture to the display time of the second picture is 75:25;

FIG. 29 is a view showing the opening/closing timing of the liquid-crystal shutters for the formation timing of the first optical image and second optical image in a case where a ratio of the display time of the first picture to the display time of the second picture is 50:50;

FIG. 30 is a view showing a picture viewed by the user in a case where a ratio of the display time of the first picture to the display time of the second picture is 50:50;

FIG. 31 is a view showing the opening/closing timing of the liquid-crystal shutters for the formation timing of the first optical image and second optical image in a case where a ratio of the display time of the first picture to the display time of the second picture is 25:75;

FIG. 32 is a view showing a picture viewed by the user in a case where a ratio of the display time of the first picture to the display time of the second picture is 25:75;

FIG. 33 is a view showing the opening/closing timing of the liquid-crystal shutters for the formation timing of the first optical image and second optical image in a case where a ratio of the display time of the first picture to the display time of the second picture is 0:100;

FIG. 34 is a block diagram showing the configuration of a picture presentation system according to a modification example of the second embodiment of the present invention;

FIG. 35 is a block diagram showing the configuration of a picture presentation system according to a third embodiment of the present invention;

FIG. 36 is a view showing a picture displayed on the screen by first picture data;

FIG. 37 is a view showing a picture displayed on the screen by second picture data;

FIG. 38 is a view showing a picture displayed on the screen by residual picture data;

FIG. 39 is a view for explaining an optical image formed on the basis of picture data;

FIG. 40 is a block diagram showing the configuration of the spectacles shown in FIG. 35;

FIG. 41 is a view showing the opening/closing timing of a left-eye liquid-crystal shutter and right-eye liquid-crystal shutter for the formation timing of the second optical image and residual optical image;

FIG. 42 is a block diagram showing the configuration of a picture presentation system according to a modification example of the third embodiment of the present invention;

FIG. 43 is a block diagram showing the configuration of a picture presentation system according to a fourth embodiment of the present invention;

FIG. 44 is a block diagram showing the configuration of the polarizing filter wheel unit shown in FIG. 43;

FIG. 45 is a plan view of the polarizing filter wheel unit shown in FIG. 44; and

FIG. 46 is a view showing the formation timing of the second optical image and residual optical image for the detection signal, first polarizing filter, and second polarizing filter.

### DETAILED DESCRIPTION OF THE INVENTION

Hereinafter, embodiments will be described with reference to the drawings.

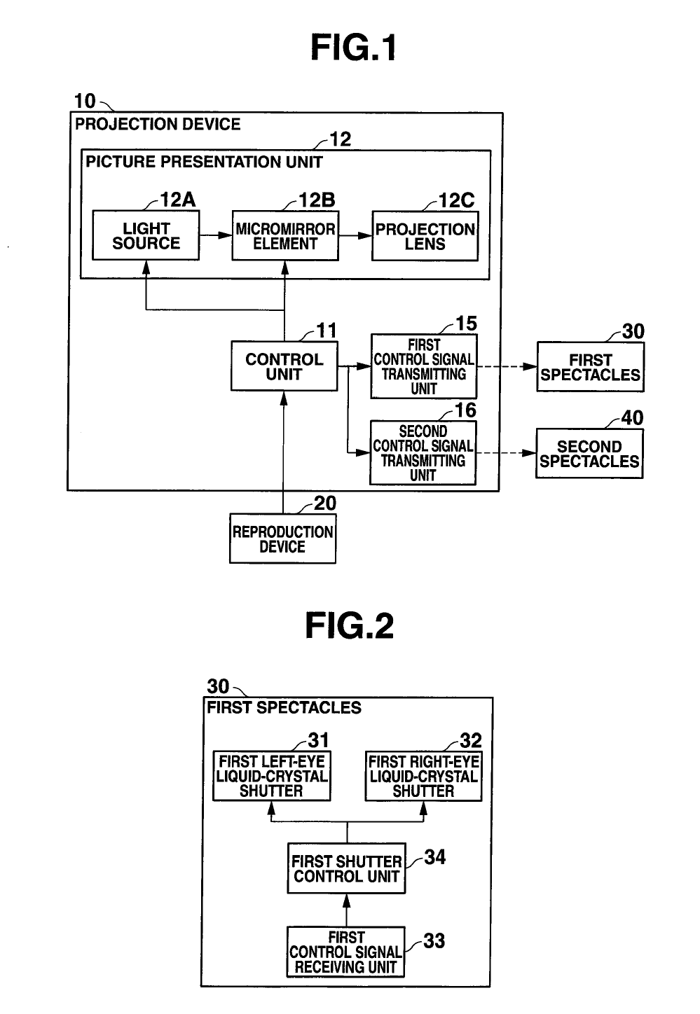

FIG. 1 is a block diagram showing the configuration of a picture presentation system according to a first embodiment of the present invention.

As shown in FIG. 1, the picture presentation system includes a projection device 10 serving as a picture presentation device, first spectacles 30 serving as a first shutter device, second spectacles 40 serving as a second shutter device, and the like.

The projection device 10 includes a control unit 11, picture presentation unit 12, first control signal transmitting unit 15, second control signal transmitting unit 16, and the like. The control unit 11 controls the picture presentation unit 12, first control signal transmitting unit 15, and second control signal transmitting unit 16 according to picture data reproduced by a reproduction device 20.

The picture presentation unit 12 includes a light source 12A, micromirror element 12B, projection lens 12C, and the like. The light source 12A cyclically emits primary color light components of red (R), green (G), and blue (B) in accordance with the control of the control unit 11 by time division. The primary color light components from the light source 12A are applied to the micromirror element 12B.

The micromirror element 12B includes a plurality of minute mirrors arranged in an array form corresponding to, for example, a wide extended graphic array (WXGA) (1280 horizontal pixels×800 vertical pixels). The micromirror element 12B carries out an on/off operation of the inclination angle of each minute mirror in accordance with the control of the control unit 11 at high speed, thereby forming an optical image by the light reflected from the minute mirrors.

The projection lens 12C projects the optical image formed by the micromirror element 12B onto a screen. The optical image is projected onto the screen, whereby a picture is displayed on the screen.

The first control signal transmitting unit 15 transmits a first control signal corresponding to the picture displayed on the screen to the first spectacles 30 under the control of the control unit 11. The second control signal transmitting unit 16 transmits a second control signal corresponding to the picture displayed on the screen to the second spectacles 40 under the control of the control unit 11. Although the first control signal and second control signal are transferred by infrared signals, the frequency of the infrared signal used to transfer the first control signal, and that of the infrared signal used to transfer the second control signal are different from each other. It should be noted that although infrared rays are used as the control signals in the present invention, signals other than the infrared rays may be used and, if setting of the control signal can be made such that the user cannot recognize the control signal by making, for example, the time for control signal transmission very short, a control signal of a wavelength in the visible light range may be used.

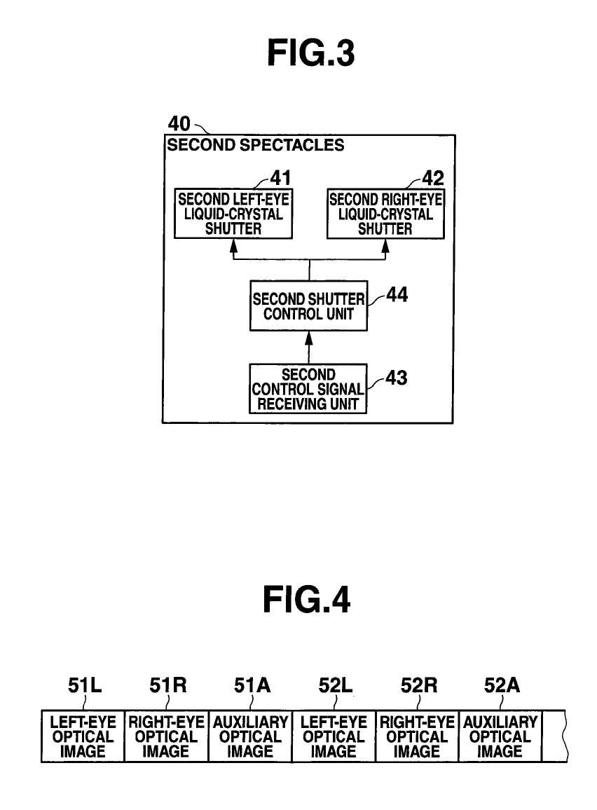

The configurations of the first spectacles 30 and second spectacles 40 will be described below with reference to the block diagrams of FIGS. 2 and 3.

The first spectacles 30 include a first left-eye liquid-crystal shutter 31, first right-eye liquid-crystal shutter 32, first control signal receiving unit 33, and first shutter control unit 34. The second spectacles 40 include a second left-eye liquid-crystal shutter 41, second right-eye liquid-crystal shutter 42, second control signal receiving unit 43, and second shutter control unit 44.

The first control signal receiving unit 33 of the first spectacles 30 receives a first control signal transmitted from the first control signal transmitting unit 15. The first control signal is a control signal used to control opening/closing of the first left-eye liquid-crystal shutter 31 and first right-eye liquid-crystal shutter 32. The second control signal receiving unit 43 of the second spectacles 40 receives a second control signal transmitted from the second control signal transmitting unit 16. The second control signal is a control signal used to control opening/closing of the second left-eye liquid-crystal shutter 41 and second right-eye liquid-crystal shutter 42.

The first control signal receiving unit 33 of the first spectacles 30 transmits the received first control signal to the first shutter control unit 34. The first shutter control unit 34 controls opening/closing of the first left-eye liquid-crystal shutter 31 and first right-eye liquid-crystal shutter 32 according to the first control signal. The second control signal receiving unit 43 of the second spectacles 40 transmits the received second control signal to the second shutter control unit 44. The second shutter control unit 44 controls opening/closing of the second left-eye liquid-crystal shutter 41 and second right-eye liquid-crystal shutter 42 according to the second control signal.

Picture data reproduced by the reproduction device 20 includes left-eye picture data, right-eye picture data, and auxiliary picture data. The left-eye picture data and right-eye picture data are data items used to show a three-dimensional picture to the user wearing the first spectacles 30 and second spectacles 40. Further, the auxiliary picture data is picture data used to display an auxiliary explanation of, for example, a three-dimensional picture on the screen.

Next, an optical image formed by the micromirror element 12B on the basis of the picture data reproduced by the reproduction device 20 will be described below with reference to FIG. 4.

As shown in FIG. 4, a left-eye optical image 51L based on the left-eye picture data, right-eye optical image 51R based on the right-eye picture data, auxiliary optical image 51A based on the auxiliary picture data, left-eye optical image 52L based on the left-eye picture data, right-eye optical image 52R based on the right-eye picture data, auxiliary optical image 52A based on the auxiliary picture data, . . . are formed in sequence by the micromirror element 12B.

It should be noted that although the formation time of each of the left-eye optical images 51L and 52L is substantially equal to the formation time of each of the right-eye optical images 51R and 52R, the formation time of each of auxiliary optical images 51A and 52A may be shorter than the formation time of the left-eye optical images 51L and 52L, and right-eye optical images 51R and 52R.

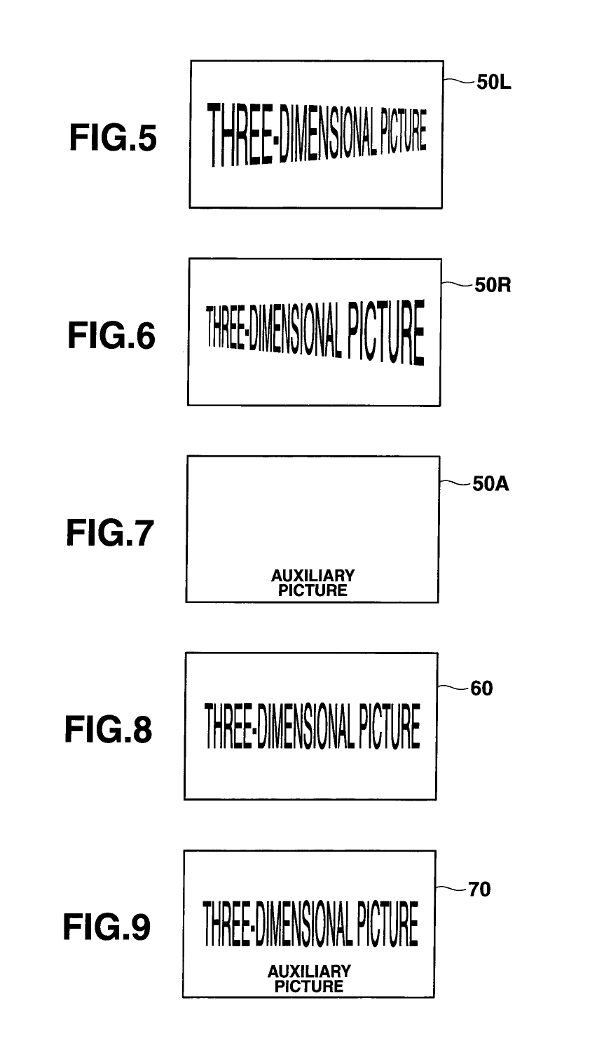

The left-eye picture 50L displayed on the screen by the left-eye optical images 51L and 52L of a case where the picture to be displayed on the screen is a still picture, right-eye picture 50R displayed on the screen by the right-eye optical images 51R and 52R of the above case, and auxiliary picture 50A displayed on the screen by auxiliary optical images 51A and 52A of the above case are shown in FIG. 5, FIG. 6, and FIG. 7, respectively.

The control unit 11 indirectly controls the opening/closing of the first left-eye liquid-crystal shutter 31 and first right-eye liquid-crystal shutter 32 by control of the first control signal transmitting unit 15 corresponding to the formation of the left-eye optical image, right-eye optical image, and auxiliary optical image. The control unit 11 selectively shows the left-eye picture 50L shown in FIG. 5 and right-eye picture 50R shown in FIG. 6 to the user wearing the first spectacles 30 by indirectly controlling the opening/closing of the first left-eye liquid-crystal shutter 31 and first right-eye liquid-crystal shutter 32. The control unit 11 selectively shows the left-eye picture 50L and right-eye picture 50R, whereby the user wearing the first spectacles 30 views the picture 60 shown in FIG. 8.

The control unit 11 indirectly controls the opening/closing of the second left-eye liquid-crystal shutter 41 and second right-eye liquid-crystal shutter 42 by control of the second control signal transmitting unit 16 corresponding to the formation of the left-eye optical image, right-eye optical image, and auxiliary optical image. The control unit 11 shows the left-eye picture 50L shown in FIG. 5, right-eye picture 50R shown in FIG. 6, and auxiliary picture 50A shown in FIG. 7 to the user wearing the second spectacles 40 by indirectly controlling the opening/closing of the second left-eye liquid-crystal shutter 41 and second right-eye liquid-crystal shutter 42. The control unit 11 shows the left-eye picture 50L, right-eye picture 50R, and auxiliary picture 50A to the user wearing the second spectacles 40, whereby the user wearing the second spectacles 40 views the picture 70 shown in FIG. 9.

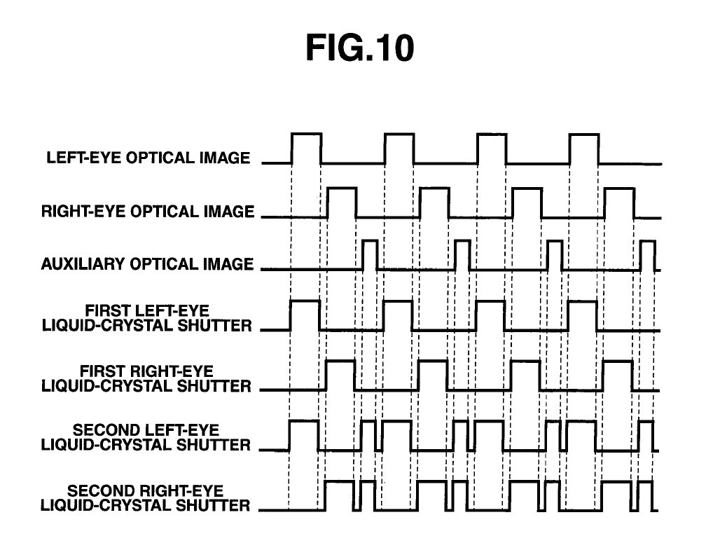

The formation timing of the left-eye optical image, right-eye optical image, and auxiliary optical image, and opening/closing timing of the first left-eye liquid-crystal shutter 31, first right-eye liquid-crystal shutter 32, second left-eye liquid-crystal shutter 41, and second right-eye liquid-crystal shutter 42 will be described below with reference to FIG. 10.

When the left-eye optical image is already formed, the first left-eye liquid-crystal shutter 31 and second left-eye liquid-crystal shutter 41 are in the opened state, and the first right-eye liquid-crystal shutter 32 and second right-eye liquid-crystal shutter 42 are in the closed state. When the right-eye optical image is already formed, the first left-eye liquid-crystal shutter 31 and second left-eye liquid-crystal shutter 41 are in the closed state, and the first right-eye liquid-crystal shutter 32 and second right-eye liquid-crystal shutter 42 are in the opened state. When the auxiliary optical image is already formed, the first left-eye liquid-crystal shutter 31 and first right-eye liquid-crystal shutter 32 are in the closed state, and the second left-eye liquid-crystal shutter 41 and second right-eye liquid-crystal shutter 42 are in the opened state. It should be noted that when the auxiliary optical image is already formed, the configuration may be made such that one of the second left-eye liquid-crystal shutter 41 and second right-eye liquid-crystal shutter 42 is in the opened state.

At the time of formation of the left-eye optical image, the first left-eye liquid-crystal shutter 31 is in the opened state, and the first right-eye liquid-crystal shutter 32 is in the closed state, and hence the first user wearing the first spectacles can view the left-eye picture with his or her left eye, but cannot view the left-eye picture with his or her right eye. At the time of formation of the right-eye optical image, the first left-eye liquid-crystal shutter 31 is in the closed state, and the first right-eye liquid-crystal shutter 32 is in the opened state, and hence the first user cannot view the right-eye picture with his or her left eye, but can view the right-eye picture with his or her right eye. As a result, it becomes possible for the first user to view a three-dimensional picture on the basis of the left-eye picture and right-eye picture. However, at the time of formation of the auxiliary optical image, the first left-eye liquid-crystal shutter 31 and first right-eye liquid-crystal shutter 32 are in the closed state, and hence the first user cannot view the picture 60 shown in FIG. 8 having no auxiliary picture.

At the time of formation of the left-eye optical image, the second left-eye liquid-crystal shutter 41 is in the opened state, and the second right-eye liquid-crystal shutter 42 is in the closed state, and hence the second user wearing the second spectacles can view the left-eye picture with his or her left eye, but cannot view the left-eye picture with his or her right eye. At the time of display of the right-eye picture, the second left-eye liquid-crystal shutter 41 is in the closed state, and the second right-eye liquid-crystal shutter 42 is in the opened state, and hence the second user cannot view the right-eye picture with his or her left eye, but can view the right-eye picture with his or her right eye. At the time of display of the auxiliary picture, the second left-eye liquid-crystal shutter 41 and the second right-eye liquid-crystal shutter 42 are in the opened state, and hence the second user can view the auxiliary picture. The second user views both the three-dimensional picture and auxiliary picture, and hence can view the picture 70 shown in FIG. 9.

According to this embodiment, the auxiliary picture is not shown to the user wearing the first spectacles 30, and the auxiliary picture is shown to the user wearing the second spectacles 40, whereby it becomes possible to make the picture viewed by the user wearing the first spectacles 30 and the picture viewed by the user wearing the second spectacles 40 different from each other.

It should be noted that in this embodiment, although the three-dimensional picture is shown to the user wearing the first spectacles 30 or the second spectacles 40, an ordinary planar picture may be shown to the user wearing the first spectacles 30 or the second spectacles 40, and the planar picture and the auxiliary picture may be shown to the user wearing the second spectacles 40.

Further, in this embodiment, although the left-eye picture, right-eye picture, and auxiliary picture are displayed on the screen by using one projection device, a first projection device configured to display the left-eye picture on the screen, second projection device configured to display the right-eye picture on the screen, and third projection device configured to display the auxiliary picture on the screen may be prepared.

### First Modification Example

It should be noted that the picture data reproduced by the reproduction device 20 may include left-eye picture data, right-eye picture data, first auxiliary picture data, and second auxiliary picture data. Further, the first auxiliary picture data and second auxiliary picture data are picture data used to display an auxiliary explanation of, for example, the three-dimensional picture on the screen.

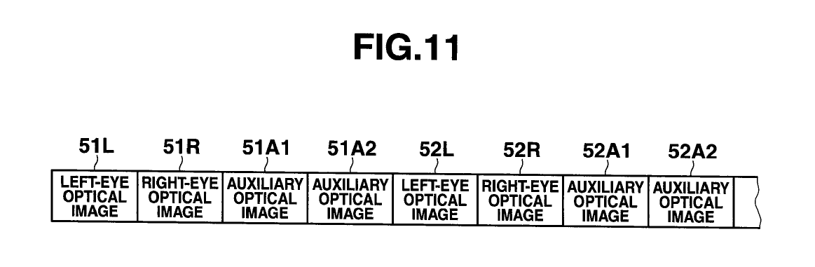

As shown in FIG. 11, the left-eye optical image 51L, right-eye optical image 51R, first auxiliary optical image 51A1 based on the first auxiliary picture data, second auxiliary optical image 51A2 based on the second auxiliary picture data, left-eye optical image 52L, right-eye optical image 52R, first auxiliary optical image 52A1 based on the first auxiliary picture data, second auxiliary optical image 52A2 based on the second auxiliary picture data, . . . may be formed in sequence by the micromirror element 12B.

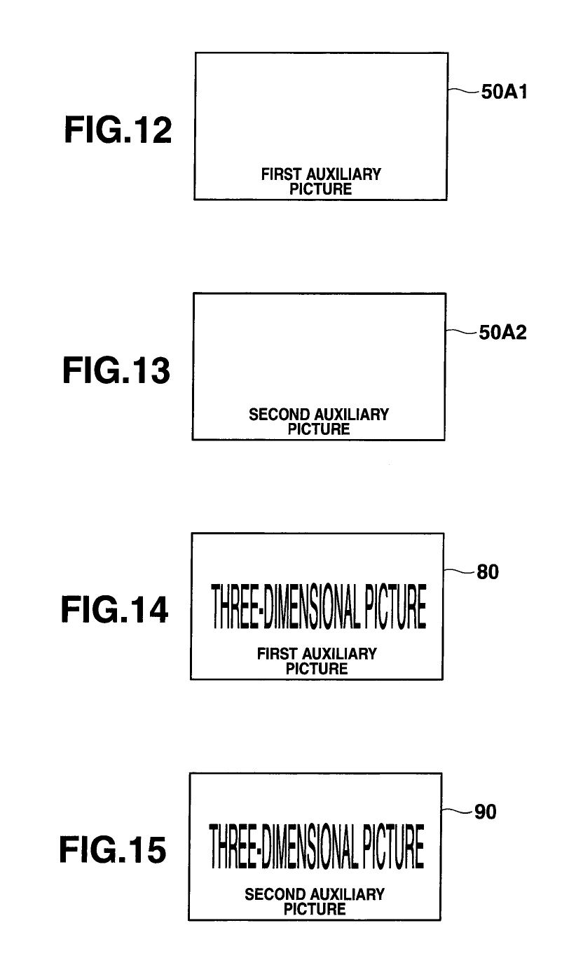

The first auxiliary picture 50A1 displayed on the screen by auxiliary optical images 51A1 and 52A1 of a case where the picture to be displayed on the screen is a still picture, and the second auxiliary picture 50A2 displayed on the screen by auxiliary optical images 51A2 and 52A2 of the above case are shown in FIG. 12 and FIG. 13, respectively.

The control unit 11 controls the first control signal transmitting unit 15 according to the formation of the left-eye optical image, right-eye optical image, first auxiliary optical image, and second auxiliary optical image to thereby indirectly control opening/closing of the first left-eye liquid-crystal shutter 31 and first right-eye liquid-crystal shutter 32. The control unit 11 selectively shows the left-eye picture 50L shown in FIG. 5, right-eye picture 50R shown in FIG. 6, and first auxiliary picture 50A1 shown in FIG. 12 to the user wearing the first spectacles 30 by indirectly controlling the opening/closing of the first left-eye liquid-crystal shutter 31 and first right-eye liquid-crystal shutter 32. The control unit 11 shows the picture 80 shown in FIG. 14 to the user wearing the first spectacles 30 by selectively showing the left-eye picture 50L, right-eye picture 50R, and first auxiliary picture 50A1.

Further, the control unit 11 controls the second control signal transmitting unit 16 according to the formation of the left-eye optical image, right-eye optical image, first auxiliary optical image, and second auxiliary optical image to thereby indirectly control opening/closing of the second left-eye liquid-crystal shutter 41 and second right-eye liquid-crystal shutter 42. The control unit 11 selectively shows the left-eye picture 50L shown in FIG. 5, right-eye picture 50R shown in FIG. 6, and second auxiliary picture 50A2 shown in FIG. 13 to the user wearing the second spectacles 40 by indirectly controlling the opening/closing of the second left-eye liquid-crystal shutter 41 and second right-eye liquid-crystal shutter 42. The control unit 11 shows the picture 90 shown in FIG. 15 to the user wearing the second spectacles 40 by selectively showing the left-eye picture 50L, right-eye picture 50R, and second auxiliary picture 50A2 to the second user wearing the second spectacles 40.

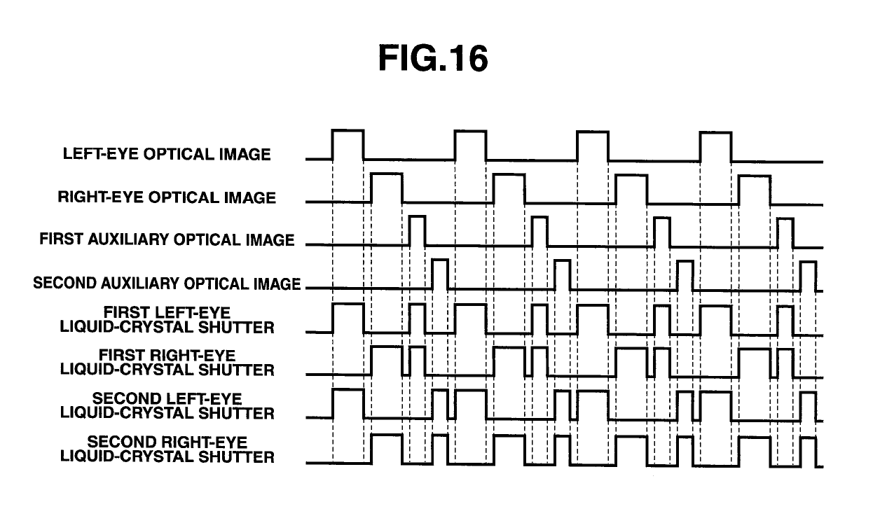

The opening/closing timing of the first left-eye liquid-crystal shutter 31, first right-eye liquid-crystal shutter 32, second left-eye liquid-crystal shutter 41, and second right-eye liquid-crystal shutter 42 for the formation timing of the left-eye optical image, right-eye optical image, first auxiliary optical image, and second auxiliary optical image will be described below with reference to FIG. 16.

When the left-eye optical image is already formed, the first left-eye liquid-crystal shutter 31 and the second left-eye liquid-crystal 41 are in the opened state, and the first right-eye liquid-crystal shutter 32 and the second right-eye liquid-crystal shutter 42 are in the closed state. When the right-eye picture is displayed, the first left-eye liquid-crystal shutter 31 and the second left-eye liquid-crystal shutter 41 are in the closed state, and the first right-eye liquid-crystal shutter 32 and the second right-eye liquid-crystal shutter 42 are in the opened state. When the first auxiliary picture is displayed, the first left-eye liquid-crystal shutter 31 and the first right-eye liquid-crystal shutter 32 are in the opened state, and the second left-eye liquid-crystal shutter 41 and the second right-eye liquid-crystal shutter 42 are in the closed state. When the second auxiliary picture is displayed, the first left-eye liquid-crystal shutter 31 and the first right-eye liquid-crystal shutter 32 are in the closed state, and the second left-eye liquid-crystal shutter 41 and the second right-eye liquid-crystal shutter 42 are in the opened state.

It should be noted that when the first auxiliary picture is displayed, one of the first left-eye liquid-crystal shutter 31 and the first right-eye liquid-crystal shutter 32 may also be in the opened state. Further, when the second auxiliary picture is displayed, one of the second left-eye liquid-crystal shutter 41 and the second right-eye liquid-crystal shutter 42 may also be in the opened state.

By controlling the opening/closing timing of the first left-eye liquid-crystal shutter 31, first right-eye liquid-crystal shutter 32, second left-eye liquid-crystal shutter 41, and second right-eye liquid-crystal shutter 42 on the basis of the timing shown in FIG. 16, it becomes possible to show the picture 80 shown in FIG. 14 to the first user wearing the first spectacles 30, and show the picture 90 shown in FIG. 15 to the second user wearing the second spectacles 40.

### Second Modification Example

It is also possible not to show the first auxiliary picture and second auxiliary picture to the third user wearing the third spectacles by changing the configuration of the device 10.

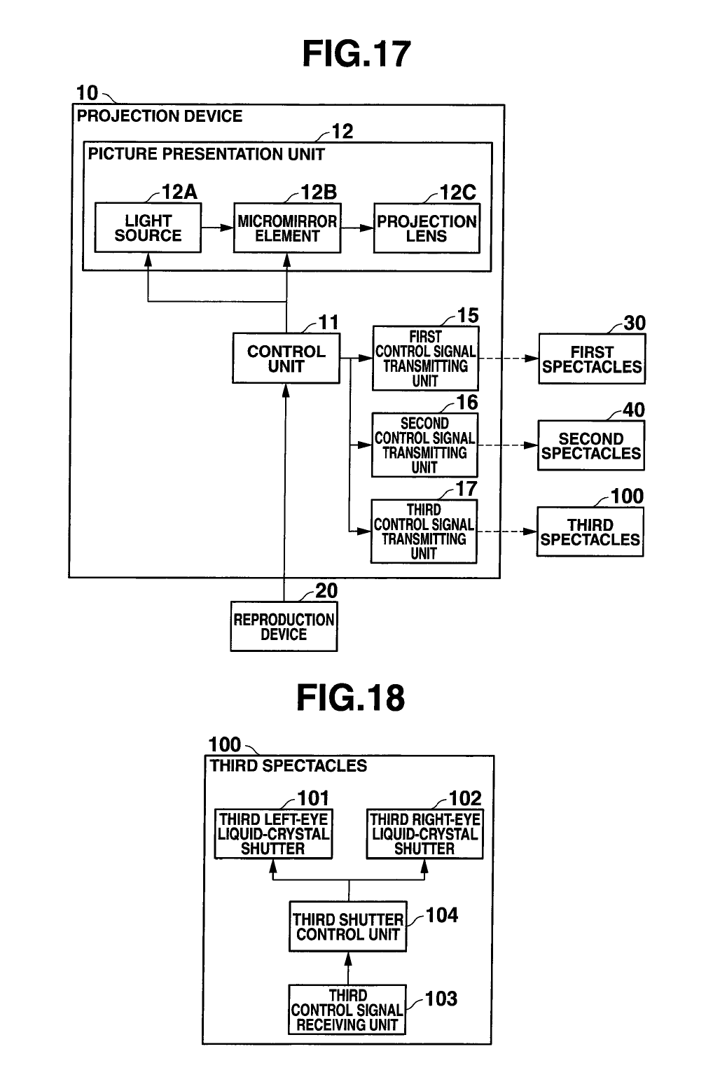

As shown in FIG. 17, the device 10 further includes a third control signal transmitting unit 17 configured to transmit a third control signal to the third spectacles 100. The third control signal transmitting unit 17 transmits a third control signal corresponding to a picture displayed on the screen to the first spectacles 30 under the control of the control unit 11. Although the third control signal is transferred by an infrared signal, the frequency of the infrared signal used to transfer the third control signal is different from the frequency of the infrared signal used to transfer the first control signal and the frequency of the infrared signal used to transfer the second control signal.

The configuration of the third spectacles 100 will be described below with reference to the block diagram of FIG. 18. The third spectacles 100 include a third left-eye liquid-crystal shutter 101, third right-eye liquid-crystal shutter 102, third control signal receiving unit 103, and third shutter control unit 104.

The third control signal receiving unit 103 receives a third control signal transmitted from the third control signal transmitting unit 17. The third control signal is a control signal used to control opening/closing of the third left-eye liquid-crystal shutter 101 and third right-eye liquid-crystal shutter 102.

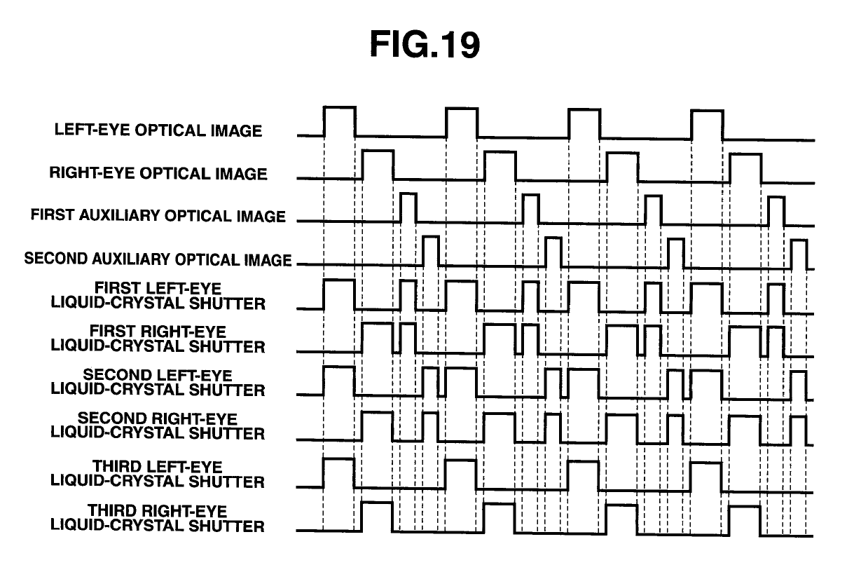

The opening/closing timing of the first left-eye liquid-crystal shutter 31, first right-eye liquid-crystal shutter 32, second left-eye liquid-crystal shutter 41, second right-eye liquid-crystal shutter 42, third left-eye liquid-crystal shutter 101, and third right-eye liquid-crystal shutter 102 for the formation timing of the left-eye optical image, right-eye optical image, first auxiliary optical image, and second auxiliary optical image will be described below with reference to FIG. 19.

When the left-eye optical image is already formed, the first left-eye liquid-crystal shutter 31, the second left-eye liquid-crystal shutter 41, and the third left-eye liquid-crystal shutter 101 are in the opened state, and the first right-eye liquid-crystal shutter 32, the second right-eye liquid-crystal shutter 42, and the third right-eye liquid-crystal shutter 102 are in the closed state. When the right-eye picture is displayed, the first left-eye liquid-crystal shutter 31, the second left-eye liquid-crystal shutter 41, and the third left-eye liquid-crystal shutter 101 are in the closed state, and the first right-eye liquid-crystal shutter 32, the second right-eye liquid-crystal shutter 42, and the third right-eye liquid-crystal shutter 102 are in the opened state. When the first auxiliary picture is displayed, the first left-eye liquid-crystal shutter 31 and the first right-eye liquid-crystal shutter 32 are in the opened state, and the second left-eye liquid-crystal shutter 41, the second right-eye liquid-crystal shutter 42, the third left-eye liquid-crystal shutter 101, and the third right-eye liquid-crystal shutter 102 are in the closed state. When the second auxiliary picture is displayed, the first left-eye liquid-crystal shutter 31, the first right-eye liquid-crystal shutter 32, the third left-eye liquid-crystal shutter 101, and the third right-eye liquid-crystal shutter 102 are in the closed state, and the second left-eye liquid-crystal shutter 41 and the second right-eye liquid-crystal shutter 42 are in the opened state.

By the timing control shown in FIG. 19, the first user wearing the first spectacles 30 views the picture 80 shown in FIG. 14. Further, by the timing control shown in FIG. 19, the second user wearing the second spectacles 40 views the picture 90 shown in FIG. 15. Further, by the timing control shown in FIG. 19, the third user wearing the third spectacles 100 views the picture 60 shown in FIG. 8.

### Third Modification Example

In the first embodiment, although the left-eye picture, right-eye picture, and auxiliary picture are presented by the projection device, the left-eye picture, right-eye picture, and auxiliary picture may be presented by displaying a picture on a display screen such as a liquid crystal display (LCD), plasma display, and the like.

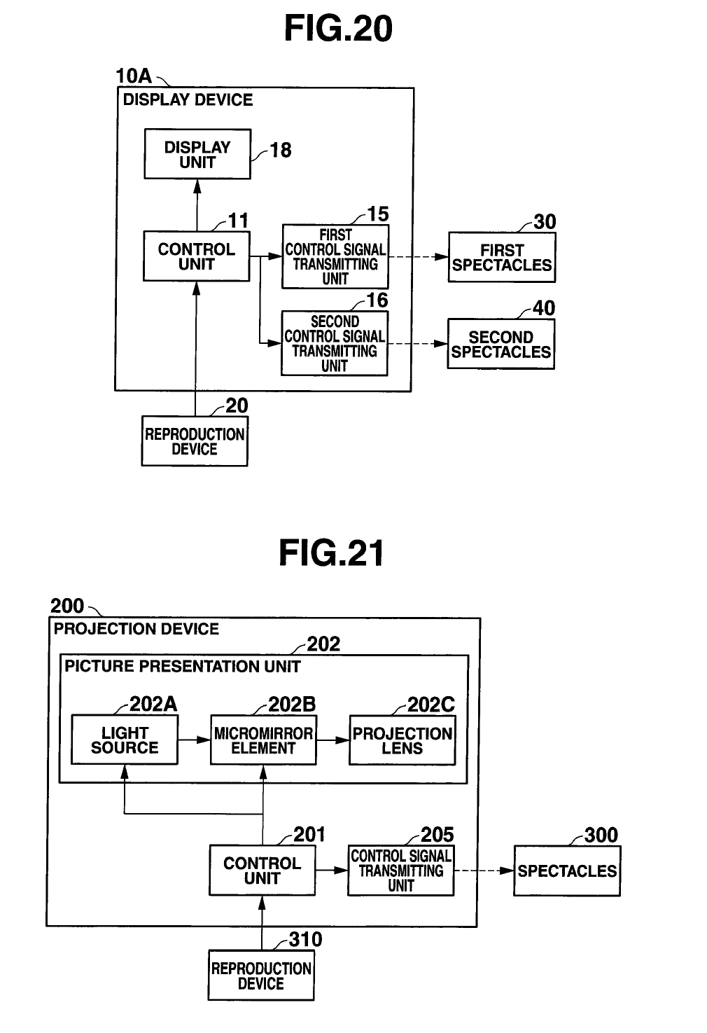

FIG. 20 is a block diagram showing the configuration of a picture presentation system according to a third modification example of the first embodiment of the present invention.

As shown in FIG. 20, the picture presentation system includes a display device 10A serving as a picture presentation device, first spectacles 30, second spectacles 40, and the like. The display device 10A includes a control unit 11, display unit 18 serving as a picture presentation unit, first control signal transmitting unit 15, second control signal transmitting unit 16, and the like.

The display unit 18 includes an LCD or a plasma display. The display unit 18 displays a left-eye picture, right-eye picture, and auxiliary picture in sequence on the display screen of the LCD or the plasma display according to the control of the control unit 11.

The display timing of the left-eye picture, right-eye picture, and auxiliary picture, and opening/closing timing of the shutters of the first spectacles 30 and second spectacles 40 are identical to the first embodiment, and hence the explanation is omitted.

In the case of this modification example, a screen need not be prepared for the first embodiment.

### Second Embodiment

FIG. 21 is a block diagram showing the configuration of a picture presentation system according to a second embodiment of the present invention.

As shown in FIG. 21, the picture presentation system includes a projection device 200 serving as a picture presentation device, spectacles 300 serving as a shutter device, and the like.

The projection device 200 includes a control unit 201, picture presentation unit 202, control signal transmitting unit 205, and the like. The control unit 201 controls the picture presentation unit 202 according to the picture data reproduced by a reproduction device 310. Further, the control unit 201 controls the control signal transmitting unit 205 according to the content item reproduced by the reproduction device 310.

The picture presentation unit 202 includes a light source 202A, micromirror element 202B, projection lens 202C, and the like. The light source 202A cyclically emits primary color light components of red (R), green (G), and blue (B) in accordance with the control of the control unit 201 by time division. The primary color light components from the light source 202A are applied to the micromirror element 202B.

The micromirror element 202B includes a plurality of minute mirrors arranged in an array form corresponding to, for example, a wide extended graphic array (WXGA) (1280 horizontal pixels×800 vertical pixels). The micromirror element 202B carries out an on/off operation of the inclination angle of each minute mirror in accordance with the control of the control unit 201 at high speed, thereby forming an optical image by the light reflected from the minute mirrors.

The projection lens 202C projects the optical image formed by the micromirror element 202B onto a screen. The optical image is projected onto the screen, whereby a picture is displayed on the screen.

The control signal transmitting unit 205 transmits a control signal for notification of the formation timing of the first optical image and second optical image to be described later to the spectacles 300 under the control of the control unit 201.

Picture data reproduced by the reproduction device 310 includes first picture data and second picture data. The first picture data is data used to present the first picture, and the second picture data is data used to present the second picture. For example, the second picture presents a perspective picture of an object presented by the first picture.

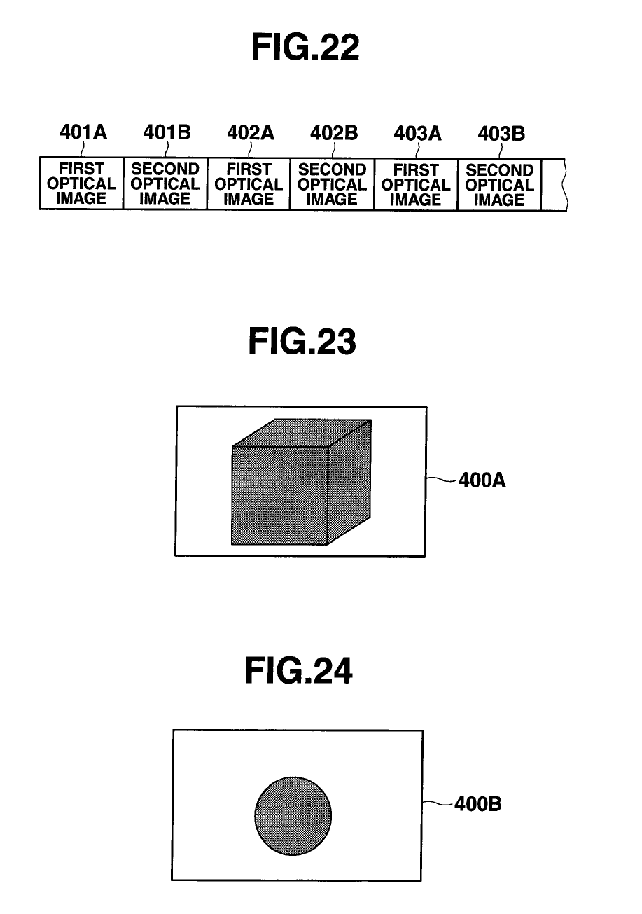

Next, the optical image formed by the micromirror element 202B on the basis of the picture data reproduced by the reproduction device 310 will be described below with reference to FIG. 22. As shown in FIG. 22, a first optical image 401A based on the first picture data, second optical image 401B based on the second picture data, first optical image 402A based on the first picture data, second optical image 402B based on the second picture data, first optical image 403A based on the first picture data, second optical image 403B based on the second picture data, . . . are formed in sequence by the micromirror element 202B.

A first picture 400A displayed on the screen by the first optical images 401A, 402A, and 403A of a case where the content item reproduced by the reproduction device 310 is a still picture, and second picture 400B displayed on the screen by the second optical images 401B, 402B, and 403B of the above case are shown in FIG. 23 and FIG. 24, respectively. As shown in FIG. 23, a cube is displayed in the first picture 400A. Further, as shown in FIG. 24, a sphere is displayed in the second picture 400B.

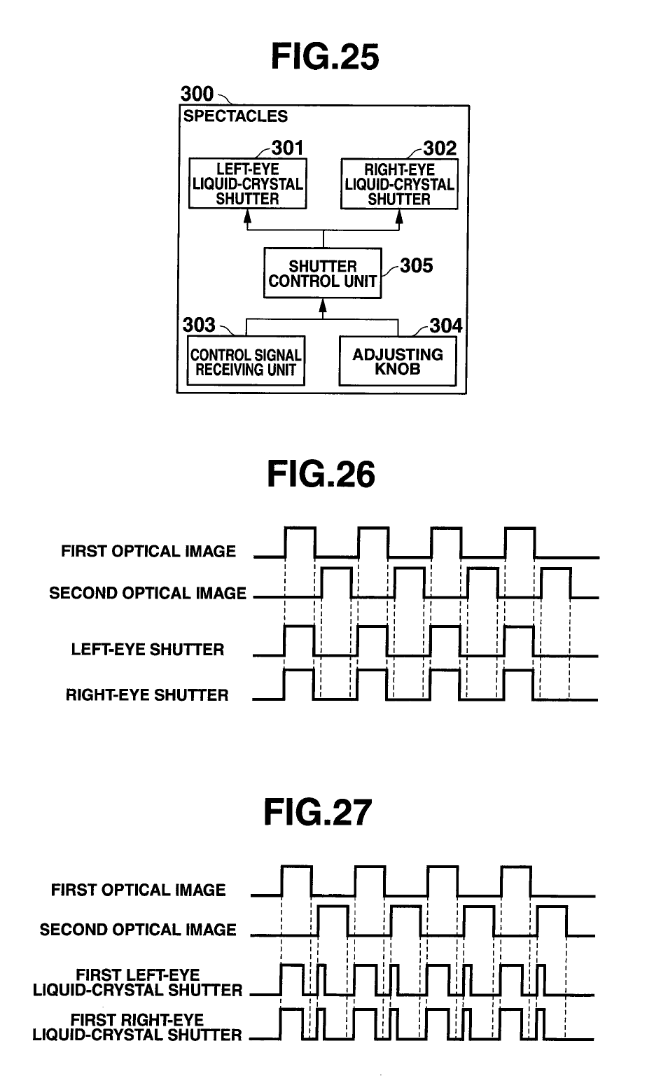

Next, the configuration of the spectacles 300 will be described below with reference to the block diagram of FIG. 25. The spectacles 300 include a left-eye liquid-crystal shutter 301, right-eye liquid-crystal shutter 302, control signal receiving unit 303, adjusting knob 304, and shutter control unit 305.

The control signal receiving unit 303 receives a control signal transmitted from the control signal transmitting unit 205. The control signal receiving unit 303 transmits the received control signal to the shutter control unit 305. The adjusting knob 304 is provided for the purpose of setting a ratio of the visual recognition time of the first picture 400A to the visual recognition time of the second picture 400B. The shutter control unit 305 controls opening/closing of the left-eye liquid-crystal shutter 301 and right-eye liquid-crystal shutter 302 according to the control signal and the setting corresponding to the position of the adjusting knob.

For example, when the ratio of the visual recognition time of the first picture 400A to the visual recognition time of the second picture 400B is 100:0, the opening/closing timing of each of the liquid-crystal shutters 301 and 302 is controlled with respect to the formation timing of each of the first optical image and second optical image as shown in FIG. 26. Assuming that the open time of each of the left-eye liquid-crystal shutter 301 and right-eye liquid-crystal shutter 302 of a case where the first optical image is already formed (a case where the first picture 400A is displayed on the screen) is 100, the open time of each of the left-eye liquid-crystal shutter 301 and right-eye liquid-crystal shutter 302 of a case where the second optical image is already formed (a case where the second picture 400B is displayed on the screen) is 0. In this case, the user wearing the spectacles 300 views the picture 400A shown in FIG. 23.

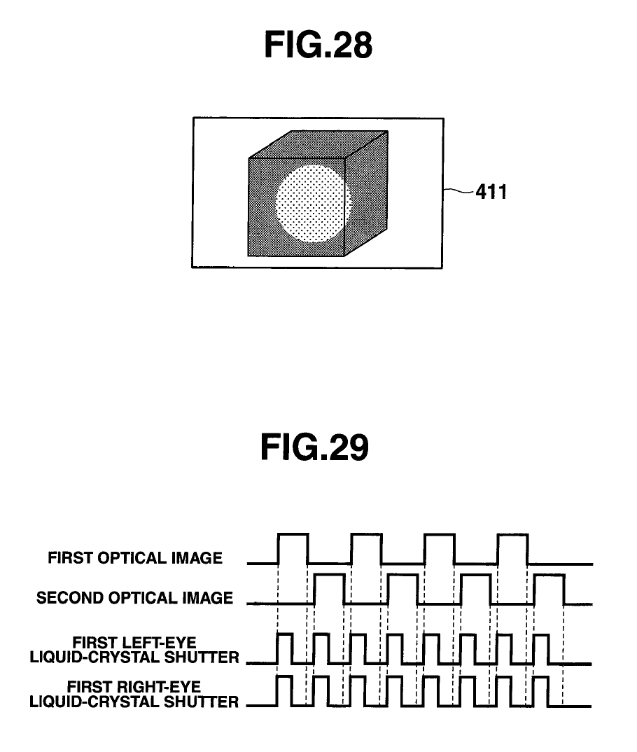

For example, when the ratio of the visual recognition time of the first picture 400A to the visual recognition time of the second picture 400B is 75:25, the opening/closing timing of each of the liquid-crystal shutters 301 and 302 is controlled with respect to the formation timing of each of the first optical image and second optical image as shown in FIG. 27. Assuming that the open time of each of the left-eye liquid-crystal shutter 301 and right-eye liquid-crystal shutter 302 of a case where the first optical image is already formed (a case where the first picture 400A is displayed on the screen) is 75, the open time of each of the left-eye liquid-crystal shutter 301 and right-eye liquid-crystal shutter 302 of a case where the second optical image is already formed (a case where the second picture 400B is displayed on the screen) is 25. In this case, the user wearing the spectacles 300 views the picture 411 shown in FIG. 28. As shown in FIG. 28, the tone of the cube becomes lighter, and the sphere can be seen thinly.

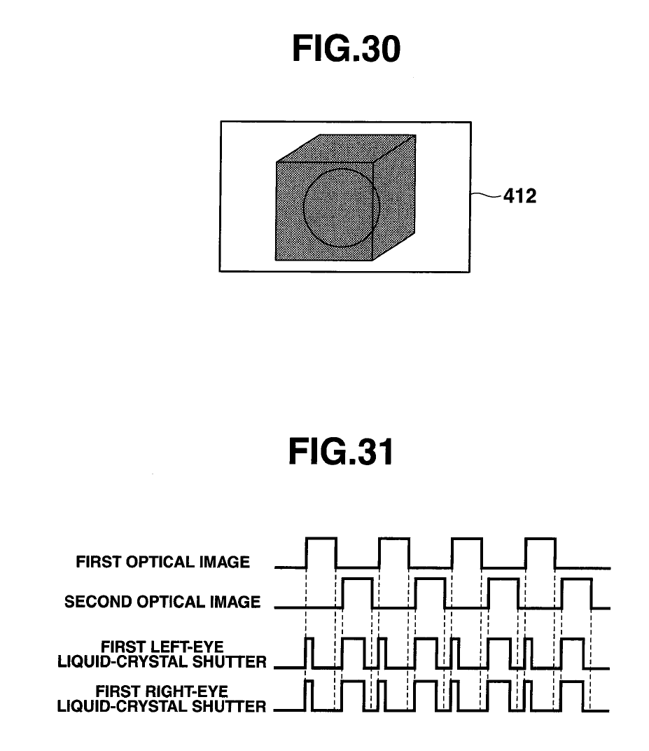

For example, when the ratio of the visual recognition time of the first picture 400A to the visual recognition time of the second picture 400B is 50:50, the opening/closing timing of each of the liquid-crystal shutters 301 and 302 is controlled with respect to the formation timing of each of the first optical image and second optical image as shown in FIG. 29. Assuming that the open time of each of the left-eye liquid-crystal shutter 301 and right-eye liquid-crystal shutter 302 of a case where the first optical image is already formed (a case where the first picture 400A is displayed on the screen) is 50, the open time of each of the left-eye liquid-crystal shutter 301 and right-eye liquid-crystal shutter 302 of a case where the second optical image is already formed (a case where the second picture 400B is displayed on the screen) is 50. In this case, the user wearing the spectacles 300 views the picture 412 shown in FIG. 30. As shown in FIG. 30, in the picture 412, the tone of the cube becomes lighter, and the sphere can be seen thinly.

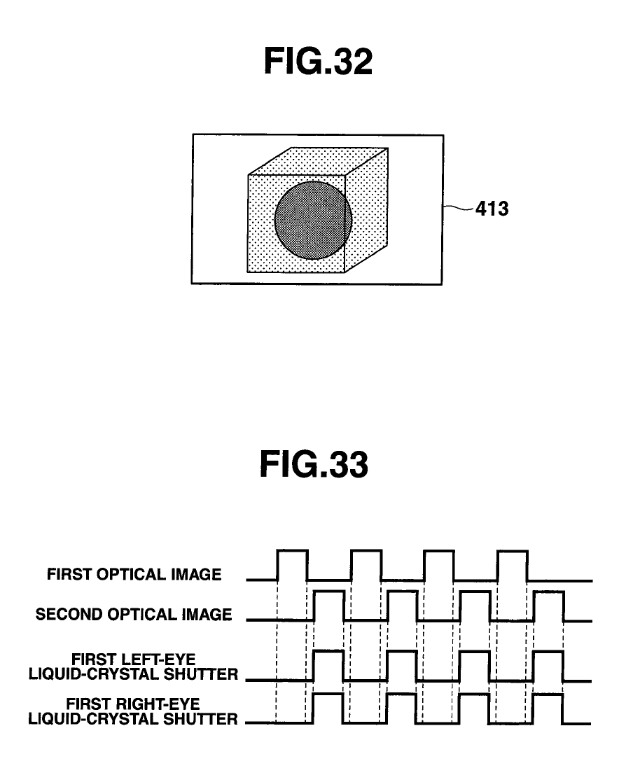

For example, when the ratio of the visual recognition time of the first picture 400A to the visual recognition time of the second picture 400B is 25:75, the opening/closing timing of each of the liquid-crystal shutters 301 and 302 is controlled with respect to the formation timing of each of the first optical image and second optical image as shown in FIG. 31. Assuming that the open time of each of the left-eye liquid-crystal shutter 301 and right-eye liquid-crystal shutter 302 of a case where the first optical image is already formed (a case where the first picture 400A is displayed on the screen) is 25, the open time of each of the left-eye liquid-crystal shutter 301 and right-eye liquid-crystal shutter 302 of a case where the second optical image is already formed (a case where the second picture 400B is displayed on the screen) is 75. In this case, the user wearing the spectacles 300 views the picture 413 shown in FIG. 32. As shown in FIG. 32, in the picture 413, the cube is seen thinly, and the sphere can be seen thinly.

For example, when the ratio of the visual recognition time of the first picture 400A to the visual recognition time of the second picture 400B is 0:100, the opening/closing timing of each of the liquid-crystal shutters 301 and 302 is controlled with respect to the formation timing of each of the first optical image and second optical image as shown in FIG. 33. Assuming that the open time of each of the left-eye liquid-crystal shutter 301 and right-eye liquid-crystal shutter 302 of a case where the first optical image is already formed (a case where the first picture 400A is displayed on the screen) is 0, the open time of each of the left-eye liquid-crystal shutter 301 and right-eye liquid-crystal shutter 302 of a case where the second optical image is already formed (a case where the second picture 400B is displayed on the screen) is 100. In this case, the user wearing the spectacles 300 views the picture 400B shown in FIG. 24. As shown in FIG. 24, in the picture 400B, the cube cannot be seen, and the sphere can be seen.

The spectacles 300 is prepared for each of a plurality of users, each of the users wearing the spectacles 300 adjusts the ratio of the visual recognition time of the first picture to the visual recognition time of the second picture by using the adjusting knob 304, whereby it becomes possible for each of the users to view a different picture.

In the case of this modification example, a screen need not be prepared for the second embodiment.

Further, in this embodiment, although the first picture and the second picture are displayed on the screen by one projection device, a first projection device configured to display the first picture on the screen, and second projection device configured to display the second picture on the screen may be prepared.

### Modification Example

In the second embodiment, although the first picture and second picture are presented by the projection device, the first picture and second picture may be presented by displaying the picture on a display screen such as a liquid crystal display (LCD), plasma display, and the like.

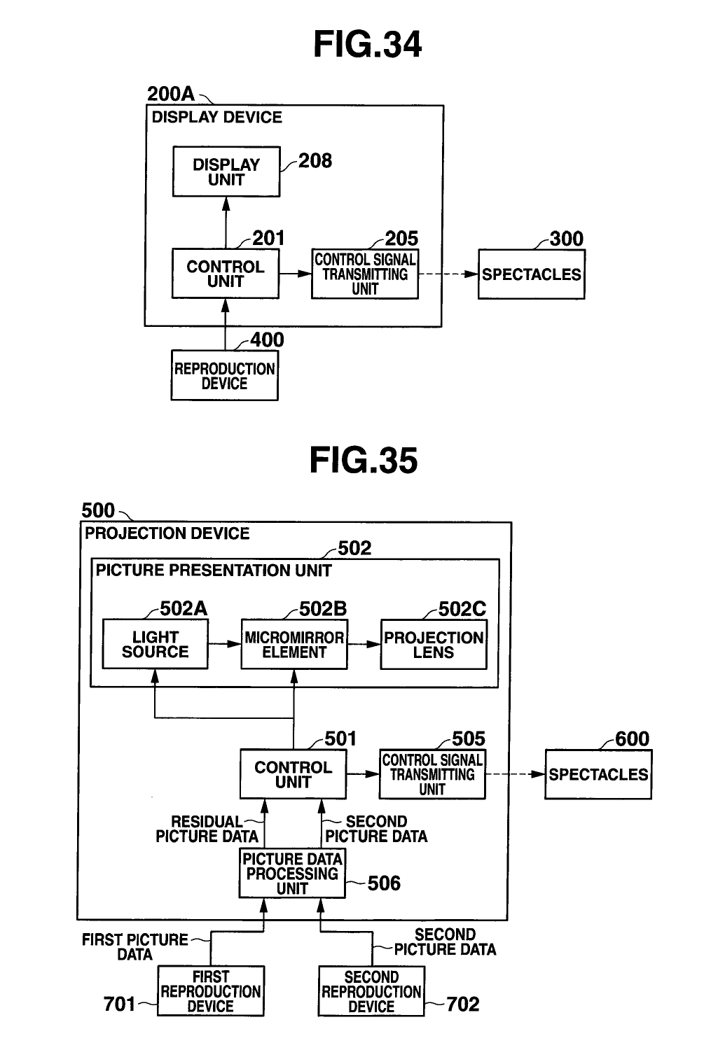

FIG. 34 is a block diagram showing the configuration of a picture presentation system according to a modification example of the second embodiment of the present invention.

As shown in FIG. 34, the picture presentation system includes a display device 200A serving as a picture presentation device, spectacles 300, and the like. The display device 200A includes a control unit 201, display unit 208 serving as a picture presentation unit, control signal transmitting unit 205, and the like.

The display unit 208 includes an LCD or a plasma display. The display unit 208 displays a first picture and second picture in sequence on the display screen of the LCD or the plasma display according to the control of the control unit 201.

The display timing of the first picture and second picture, and opening/closing timing of the shutters of the spectacles 300 are identical to the second embodiment, and hence the explanation is omitted.

### Third Embodiment

FIG. 35 is a block diagram showing the configuration of a picture presentation system according to a third embodiment of the present invention.

As shown in FIG. 35, the picture presentation system includes a projection device 500 serving as a picture presentation device, spectacles 600 serving as a shutter device, and the like.

The projection device 500 includes a control unit 501, picture presentation unit 502, control signal transmitting unit 505, picture data processing unit 506, and the like.

The picture data processing unit 506 receives first picture data transferred from a first preproduction device 701 and second picture data transferred from a second reproduction device 702. The picture data processing unit 506 generates residual picture data obtained by subtracting the second picture data from the first picture data. The picture data processing unit 506 transfers the second picture data and residual picture data to the control unit.

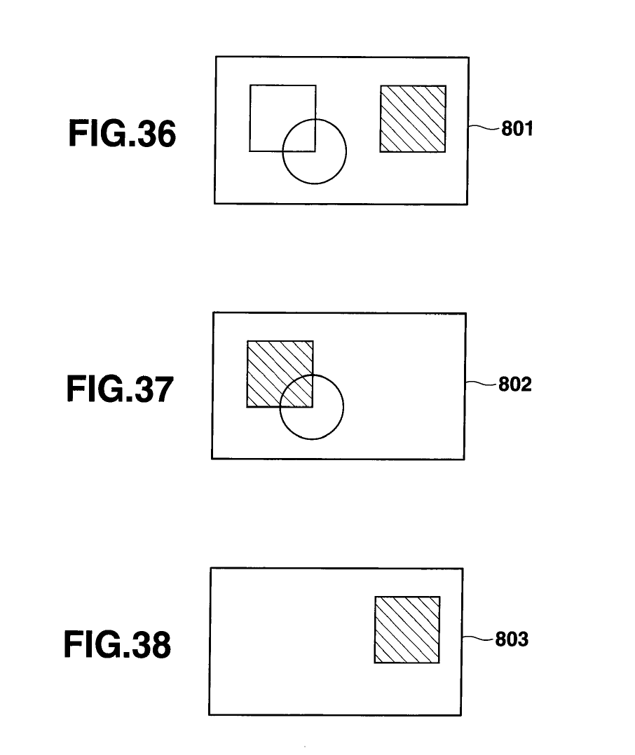

For example, when the picture 801 shown in FIG. 36 is shown by the first picture data and the picture 802 shown in FIG. 37 is shown by the second picture data, the picture data processing unit 506 generates residual picture data used to display the picture 803 shown in FIG. 38.

The picture data processing unit 506 carries out an operation of subtracting the second picture data from the first picture data for each pixel corresponding to the first picture data and second picture data. The picture data processing unit 506 subtracts information about each color component in the pixels in the second picture data from information about each color component in the pixels in the first picture data. In the case of the RGB system, each pixel of the first picture data and second picture data has red information, green information, and blue information as information about the color component. Each of the red information, green information, and blue information is generally expressed as an 8-bit value.

The picture data processing unit 506 calculates residual red information obtained by subtracting red information in one pixel of the second picture data from red information in one pixel of the first picture data, residual green information obtained by subtracting green information in one pixel of the second picture data from green information in one pixel of the first picture data, and residual blue information obtained by subtracting blue information in one pixel of the second picture data from blue information in one pixel of the first picture data.

The picture data processing unit 506 generates the residual picture data from the first picture data and second picture data, whereby it is not necessary to prepare the residual picture data in advance.

The control unit 501 controls the picture presentation unit 502 according to the second picture data and residual picture data. Further, the control unit 501 controls the control signal transmitting unit 505 according the second picture data and residual picture data.

The picture presentation unit 502 includes a light source 502A, micromirror element 502B, projection lens 502C, and the like. The light source 502A cyclically emits primary color light components of red (R), green (G), and blue (B) in accordance with the control of the control unit 501 by time division. The primary color light components from the light source 502A are applied to the micromirror element 502B.

The micromirror element 502B includes a plurality of minute mirrors arranged in an array form corresponding to, for example, a wide extended graphic array (WXGA) (1280 horizontal pixels×800 vertical pixels). The micromirror element 502B carries out an on/off operation of the inclination angle of each minute mirror in accordance with the control of the control unit at high speed, thereby forming an optical image by the light reflected from the minute mirrors.

The projection lens 502C projects the optical image formed by the micromirror element 502B onto a screen. The optical image is projected onto the screen, whereby a picture is displayed on the screen.

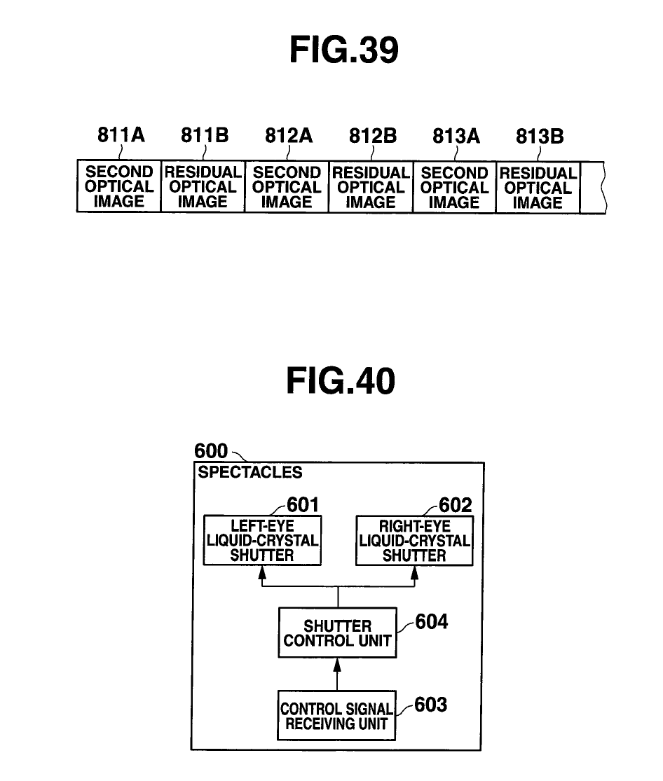

Next, the optical image formed by the micromirror element 502B on the basis of the second picture data and residual picture data will be described below with reference to FIG. 39. As shown in FIG. 39, a second optical image 811A based on the second picture data, residual optical image 811B based on the residual picture data, second optical image 812A based on the second picture data, residual optical image 812B based on the residual picture data, second optical image 813A based on the second picture data, and residual optical image 813B based on the residual picture data are formed in sequence by the micromirror element 502B.

Next, the configuration of the spectacles 600 will be described below with reference to the block diagram of FIG. 40. The spectacles 600 include a left-eye liquid-crystal shutter 601, right-eye liquid-crystal shutter 602, control signal receiving unit 603, and shutter control unit 604.

The control signal receiving unit 603 receives a control signal transmitted from the control signal transmitting unit 505. The control signal is a control signal used to control opening/closing of the left-eye liquid-crystal shutter 601 and right-eye liquid-crystal shutter 602.

The control signal receiving unit 603 transmits the received control signal to the shutter control unit 604. The shutter control unit 604 controls opening/closing of the left-eye liquid-crystal shutter 601 and right-eye liquid-crystal shutter 602 according to the control signal.

As shown in FIG. 39, the control unit 501 of the projection device 500 controls the light source 502A and micromirror element 502B such that the second optical images 811A, 812A, 813A, . . . based on the second picture data and the residual optical images 811B, 8123, 813B, . . . based on the residual picture data are alternately projected onto the screen.

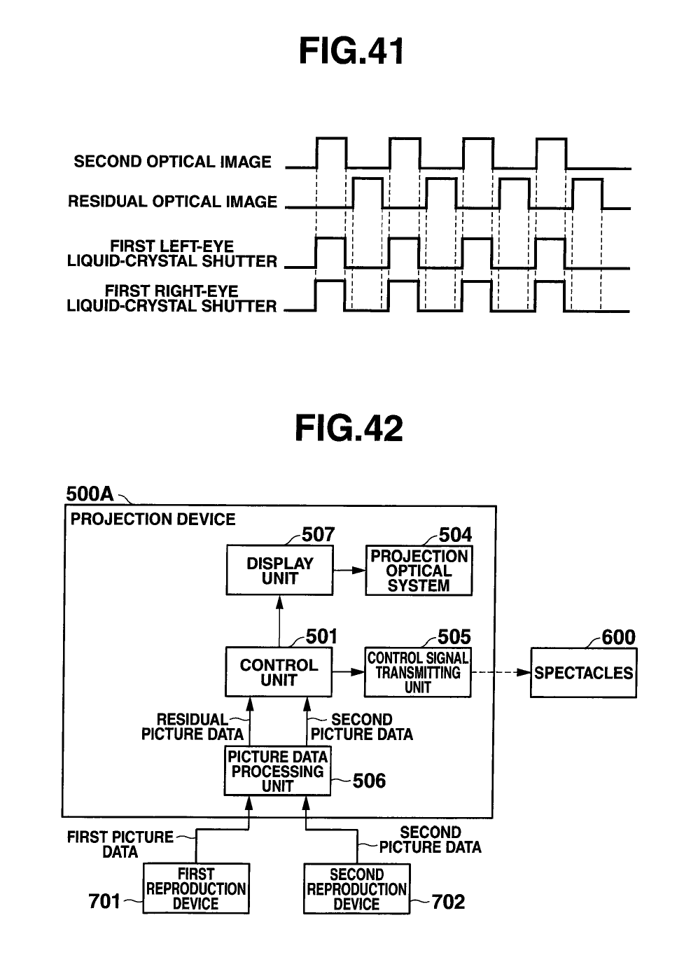

The opening/closing timing of each of the left-eye liquid-crystal shutter 601 and right-eye liquid-crystal shutter 602 for the formation timing of each of the second optical image and residual optical image will be described below with reference to FIG. 41.

As shown in FIG. 41, when the second optical image is formed (when the second picture 802 is displayed on the screen), the left-eye liquid-crystal shutter 601 and right-eye liquid-crystal shutter 602 are in the opened state and, when the residual optical image is formed (when the residual picture 803 is displayed on the screen), the left-eye liquid-crystal shutter 601 and right-eye liquid-crystal shutter 602 are in the closed state.

The user wearing the spectacles 600 views only the picture 802 displayed on the screen by the second optical image without viewing the residual picture 803 displayed on the screen by the residual optical image. As a result, the user wearing the spectacles 600 views the picture 802 shown in FIG. 37.

The user not wearing spectacles 600 views both the picture 802 displayed on the screen by the second optical image and picture 803 displayed on the screen by the residual optical image. The user not wearing spectacles 600 views a picture formed by adding the picture 802 and picture 803 together because of an afterimage. The picture 803 is a picture displayed by the residual picture data obtained by subtracting the second picture data from the first picture data, and the picture 802 is a picture displayed by the second picture data, and hence the user not wearing spectacles 600 views the picture 801.

According to this embodiment, it becomes possible to show the picture 802 shown in FIG. 37 to the user wearing the spectacles 600, and show the picture 801 shown in FIG. 36 to the user not wearing spectacles 600.

It should be noted that in this embodiment, the first picture data and second picture data are input to the projection device 500, and the picture data processing unit 506 prepares the residual picture data from the first picture data and second picture data. However, the residual picture data may be prepared in advance, and the second picture data and residual picture data may be input to the projection device 500. In this case, the picture data processing unit 506 may not be provided in the projection device 500.

Further, in this embodiment, although the second picture and residual picture are displayed on the screen by one projection device, a first projection device configured to display the second picture on the screen, and second projection device configured to display the residual picture on the screen may be prepared.

### Modification Example

In the third embodiment, although the second picture and residual picture are presented by the projection device, the second picture and residual picture may be presented by displaying a picture on a display screen such as a liquid crystal display (LCD), plasma display, and the like.

FIG. 42 is a block diagram showing the configuration of a picture presentation system according to a modification example of the third embodiment of the present invention.

As shown in FIG. 42, the picture presentation system includes a display device 500A serving as a picture presentation device, spectacles 600, and the like. The display device 500A includes a control unit 501, picture data processing unit 506, control signal transmitting unit 505, display unit 507, and the like.

In the case of this modification example, a screen need not be prepared for the third embodiment.

The display unit 507 includes an LCD or a plasma display. The display unit 507 displays the second picture and residual picture in sequence on the display screen of the LCD or the plasma display according to the control of the control unit 501.

The display timing of the second picture and residual picture, and opening/closing timing of the shutters of the spectacles 600 are identical to the third embodiment, and hence the explanation is omitted.

### Fourth Embodiment

In the third embodiment, the pictures are selectively shown to the user wearing the spectacles by using the liquid-crystal shutters. In this embodiment, an example in which a picture is shown to the user wearing spectacles including polarizing filters will be described.

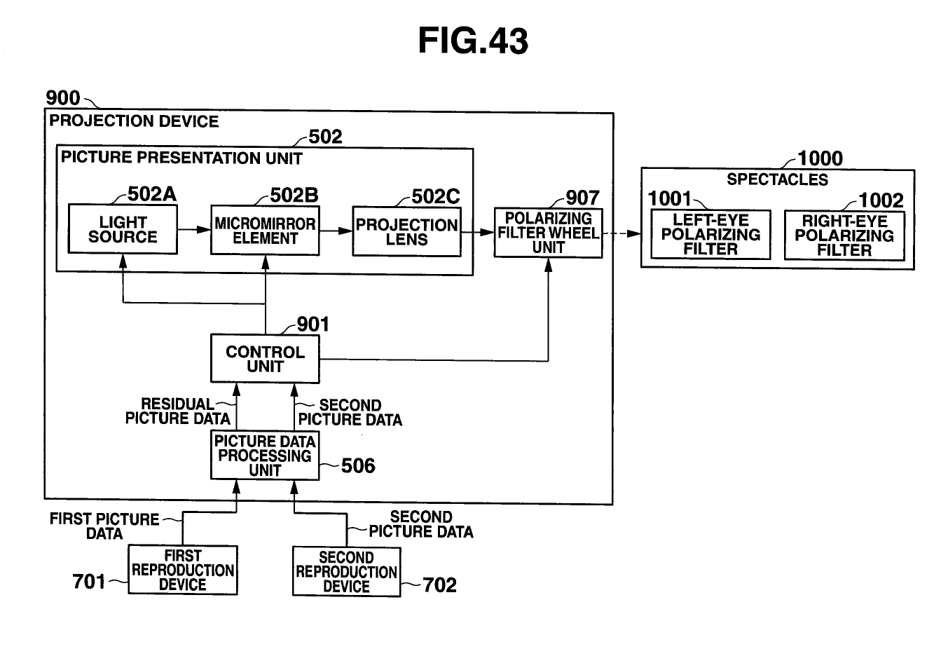

FIG. 43 is a block diagram showing the configuration of a picture presentation system according to a fourth embodiment of the present invention.

As shown in FIG. 43, the picture presentation system includes a projection device 900 serving as a picture presentation device, spectacles 1000 serving as a filter device, and the like.

The projection device 900 includes a control unit 901, picture presentation unit 502, picture data processing unit 506, polarizing filter wheel unit 907, and the like.

The functions of the light source 502A, micromirror element 502B, and projection lens 502C of the picture presentation unit 502, and picture data processing unit 506 are identical to those described in the third embodiment, and hence the explanation is omitted.

The control unit 901 controls, in the same manner as the control unit 501 of the third embodiment, as shown in FIG. 39, the light source 502A and micromirror element 502B such that the second optical images 811A, 812A, 813A, . . . based on the second picture data and the residual optical images 811B, 812B, 813B, . . . based on the residual picture data are alternately formed.

Further, the spectacles 1000 include a left-eye polarizing filter 1001 and right-eye polarizing filter 1002. The left-eye polarizing filter 1001 and right-eye polarizing filter 1002 are optical elements configured to convert transmitted light into linearly polarized light. The polarizing axis of the left-eye polarizing filter 1001 and polarizing axis of the right-eye polarizing filter 1002 are parallel with each other.

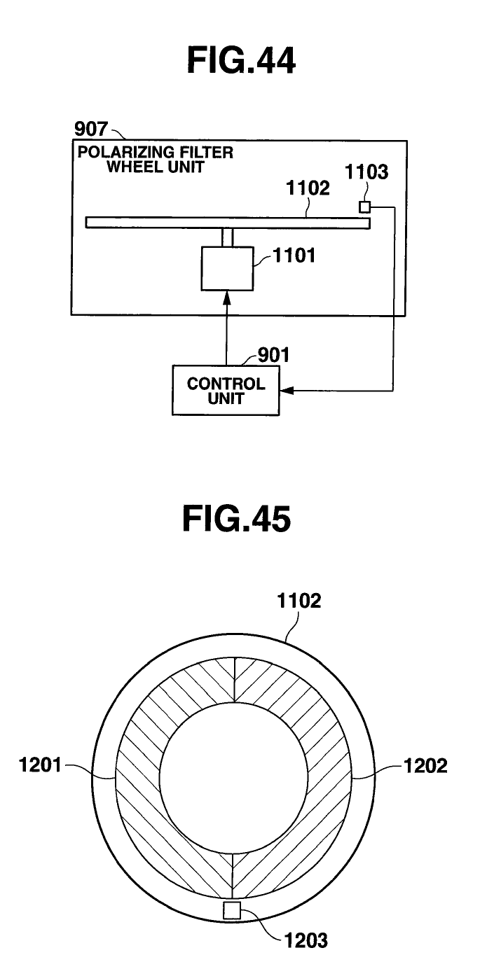

The configuration of the polarizing filter wheel unit 907 will be described below with reference to FIG. 44.

The polarizing filter wheel unit 907 is provided with a wheel motor 1101, polarizing filter wheel 1102, marker sensor 1103, and the like.

The wheel motor 1101 rotates the polarizing filter wheel 1102 according to the control of the control unit 901. The configuration of the polarizing filter wheel 1102 will be described below with reference to the plan view of FIG. 45. As shown in FIG. 45, the polarizing filter wheel 1102 is provided with a first polarizing filter 1201, second polarizing filter 1202, and marker 1203. The first polarizing filter 1201 and second polarizing filter 1202 are optical elements configured to convert transmitted light into linearly polarized light. The polarizing axis of the first polarizing filter 1201 and polarizing axis of the second polarizing filter 1202 intersect each other at right angles. The polarizing axis of the first polarizing filter 1201 is parallel with the polarizing axes of the left-eye polarizing filter 1001 and right-eye polarizing filter 1002 of the spectacles 1000.

The marker 1203 is provided at one end of the circumferential surface of the polarizing filter wheel 1102. The marker 1203 and marker sensor 1103 are arranged such that the marker 1203 passes through the detection area of the marker sensor 1103 when the polarizing filter wheel 1102 is rotated. Each time the polarizing filter wheel 1102 makes one rotation, the marker sensor 1103 detects the marker 1203. The marker sensor 1103 outputs a detection signal to the control unit 901 each time the sensor 1103 detects the marker 1203.

The control unit 901 controls the rotation of the wheel motor 1101 on the basis of the detection interval of the detection signal such that the time during which the polarizing filter wheel 1102 makes one rotation becomes a preset time. Further, the control unit 901 controls the projection timing of the second optical images 811A, 812A, 813A, . . . based on the second picture data and residual optical images 811B, 812B, 813B, . . . based on the residual picture data according to the detection signal.

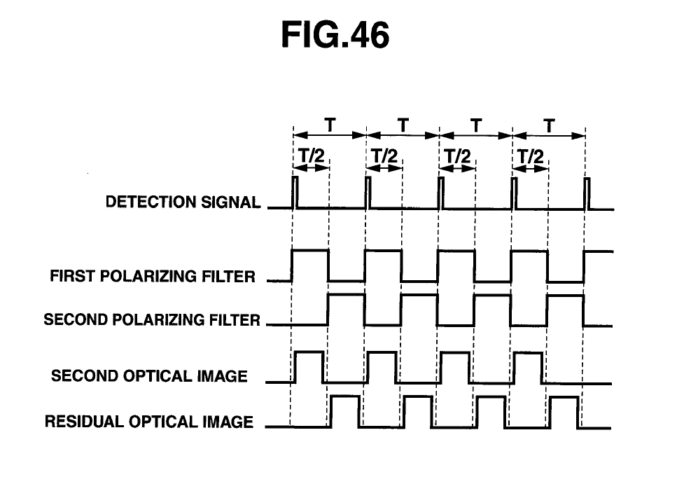

The formation timing of the second optical image and residual optical image for the detection signal, first polarizing filter 1201 and second polarizing filter 1202 will be described below with reference to FIG. 46.

At the time of detection of the detection signal, the light exiting from the optical lens passes through the first polarizing filter 1201. After the detection of the detection signal, the control unit 901 controls the light source 502A and micromirror element 502B to form the second optical image. Before a time corresponding to T/2 (T is the time during which the polarizing filter wheel 1102 makes one rotation) elapses from the detection of the detection signal, the control unit 501 controls the light source 502A and micromirror element 502B not to form the second optical image. After an elapse of time T/2 from the detection of the detection signal, the light exiting from the optical lens passes through the second polarizing filter 1202. After an elapse of time T/2 from the detection of the detection signal, the control unit 901 controls the light source 502A and micromirror element 502B to form the residual optical image. Before time T elapses from the detection of the detection signal, the control unit 501 controls the light source 502A and micromirror element 502B not to form the residual optical image.

The polarizing axis of the first polarizing filter 1201 is parallel with the polarizing axes of the left-eye polarizing filter 1001 and right-eye polarizing filter 1002 of the spectacles 1000. The polarizing axis of the second polarizing filter 1202 intersects the polarizing axes of the left-eye polarizing filter 1001 and right-eye polarizing filter 1002 of the spectacles 1000 at right angles. Accordingly, it becomes possible for the user wearing the spectacles 1000 to view only the picture displayed on the screen on the basis of the optical image (second optical image) passing through the first polarization filter 1201 without viewing the picture displayed on the screen by the optical image (residual optical image) passing through the second polarization filter 1202.

The user not wearing spectacles 1000 views both the picture 802 displayed on the screen by the second optical images 811A, 812A, and 813A, and picture 803 displayed on the screen by the residual optical images 811B, 812B, and 813B. The user not wearing spectacles 1000 views a picture formed by adding the picture 802 and picture 803 together because of an afterimage. The picture 803 is a picture displayed by the residual picture data obtained by subtracting the second picture data from the first picture data, and the picture 802 is a picture displayed by the second picture data, and hence the user not wearing spectacles 1000 views the picture 801.

According to this embodiment, it becomes possible to show the picture 802 shown in FIG. 37 to the user wearing the spectacles 1000, and show the picture 801 shown in FIG. 36 to the user not wearing spectacles 1000. Further, the spectacles 1000 can be produced at lower cost than the spectacles 600 of the third embodiment.

In this embodiment, although the transmitted light of the first polarizing filter 1201 or the second polarizing filter 1202 is converted into the linearly polarized light, for example, a filter configured to convert the transmitted light into left-handed circularly polarized light at the time of formation of the second optical image may be opposed to the optical lens and, for example, a filter configured to convert the transmitted light into right-handed circularly polarized light at the time of formation of the residual optical image may be opposed to the optical lens. When the transmitted light is converted into the left-handed circularly polarized light or the right-handed circularly polarized light, the light reflected from the screen has circular polarization opposite to the circular polarization of the incident light. Accordingly, in a case where the light passes through a filter configured to convert the transmitted light into left-handed circularly polarized light at the time of formation of the second optical image, an optical element configured to convert the transmitted light into right-handed circularly polarized light is used for each of the left-eye polarizing filter 1001 and right-eye polarizing filter 1002 of the spectacles 1000.

Further, in this embodiment, although the second picture and residual picture are displayed on the screen by one projection device, a first projection device configured to display the second picture on the screen, and second projection device configured to display the residual picture on the screen may be prepared.

Besides, the present invention is not limited to the aforementioned embodiments, and can be variously modified in the implementation stage within the scope not deviating from the gist of the invention. Further, functions to be executed in the aforementioned embodiments may be appropriately combined with each other to the utmost to be implemented. Various stages are included in the aforementioned embodiments, and by appropriate combination of a plurality of disclosed constituent elements, various inventions can be extracted. For example, even when some constituent elements are deleted from all the constituent elements shown in the embodiments, the constitution from which some constituent elements are deleted can be extracted as an invention when an advantage can be obtained from the constitution.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A picture presentation system comprising:
a first shutter device that includes:
a first shutter corresponding to one eye of a first user,
a second shutter corresponding to the other eye of the first user,
a first receiving unit configured to receive a first control signal used to control opening/closing of the first shutter and the second shutter, and
a first control unit configured to control opening/closing of the first shutter and the second shutter on the basis of the first control signal;
a second shutter device that includes:
a third shutter corresponding to one eye of a second user,
a fourth shutter corresponding to the other eye of the second user,
a second receiving unit configured to receive a second control signal used to control opening/closing of the third shutter and the fourth shutter, and
a second control unit configured to control opening/closing of the third shutter and the fourth shutter on the basis of the second control signal; and
a picture presentation device that includes:
a picture presentation unit configured to present a first picture and a second picture in sequence,
a first control signal transmitting unit configured to transmit the first control signal to bring the first shutter and the second shutter into a closed state when the second picture is presented, and
a second control signal transmitting unit configured to transmit the second control signal to bring at least one of the third shutter and the fourth shutter into an opened state when the second picture is presented.

2. The picture presentation system according to claim 1, wherein:
the picture presentation unit presents the first picture, the second picture, and a third picture in sequence,
the first control signal transmitting unit transmits the first control signal to bring at least one of the first shutter and the second shutter into the opened state when the third picture is presented, and
the second control signal transmitting unit transmits the second control signal to bring the third shutter and the fourth shutter into the closed state when the third picture is presented.

3. The picture presentation system according to claim 1, wherein:
the picture presentation unit displays the first picture, the fourth picture, and the second picture in sequence,
the first control signal transmitting unit transmits a control signal used to i) bring one of the first shutter and the second shutter into the opened state, and bring the other one of the first shutter and the second shutter into the closed state when the first picture is presented, and ii) bring one of the first shutter and the second shutter into the closed state, and bring the other one of the first shutter and the second shutter into the opened state when the fourth picture is presented, and
the second control signal transmitting unit transmits a control signal used to i) bring one of the third shutter and the fourth shutter into the opened state, and bring the other one of the third shutter and the fourth shutter into the closed state when the first picture is presented, and ii) bring one of the third shutter and the fourth shutter into the closed state, and bring the other one of the third shutter and the fourth shutter into the opened state when the fourth picture is presented.

4. The picture presentation system according to claim 1, further comprising a third shutter device including:
a fifth shutter corresponding to one eye of a third user,
a sixth shutter corresponding to the other eye of the third user,
a third receiving unit configured to receive a third control signal used to control opening/closing of the fifth shutter and the sixth shutter, and
a third control unit configured to control opening/closing of the fifth shutter and the sixth shutter on the basis of the third control signal, wherein:
the picture presentation unit presents the first picture, the second picture, and a third picture in sequence,
the picture presentation device further includes a third control signal transmitting unit configured to transmit the third control signal to i) bring the fifth shutter and the sixth shutter into the closed state when the second picture is presented, and ii) bring at least one of the fifth shutter and the sixth shutter into the opened state when the third picture is presented,
the first control signal transmitting unit transmits the first control signal to bring the first shutter and the second shutter into the closed state when the third picture is presented, and
the second control signal transmitting unit transmits the second control signal to bring the third shutter and the fourth shutter into the closed state when the third picture is presented.

5. The picture presentation system according to claim 4, wherein:
the picture presentation unit displays the first picture, the fourth picture, the second picture, and the third picture in sequence,
the first control signal transmitting unit transmits the first control signal to i) bring one of the first shutter and the second shutter into the opened state, and bring the other one of the first shutter and the second shutter into the closed state when the first picture is presented, and ii) bring one of the first shutter and the second shutter into the closed state, and bring the other one of the first shutter and the second shutter into the opened state when the fourth picture is presented,
the second control signal transmitting unit transmits the second control signal to i) bring one of the third shutter and the fourth shutter into the opened state, and bring the other one of the third shutter and the fourth shutter into the closed state when the first picture is presented, and ii) bring one of the third shutter and the fourth shutter into the closed state, and bring the other one of the third shutter and the fourth shutter into the opened state when the fourth picture is presented, and
the third control signal transmitting unit transmits the third control signal to i) bring one of the fifth shutter and the sixth shutter into the opened state, and bring the other one of the fifth shutter and the sixth shutter into the closed state when the first picture is presented, and ii) bring one of the fifth shutter and the sixth shutter into the closed state, and bring the other one of the fifth shutter and the sixth shutter into the opened state when the third picture is presented.

6. The picture presentation system according to claim 1, wherein the picture presentation unit includes:
an optical image formation unit configured to form optical images corresponding to the first picture and the second picture, and
a projection unit configured to project the optical images formed by the optical image formation unit onto a projection object.

7. The picture presentation system according to claim 1, wherein the picture presentation unit includes a display unit configured to display the first picture and the second picture.

8. A picture presentation system comprising:
a picture presentation device that includes:
a picture presentation unit configured to alternately present a first picture and a second picture, and
a transmitting unit configured to transmit a control signal indicating a case where the first picture is presented and a case where the second picture is presented; and
a shutter device that includes:
a shutter,
a receiving unit configured to receive the control signal,
a setting unit configured to set a ratio of a time for visual recognition of the first picture to a time for visual recognition of the second picture, and
a control unit configured to control opening/closing of the shutter on the basis of the control signal, and the setting set by the setting unit.

9. The picture presentation system according to claim 8, wherein the picture presentation unit includes:
an optical image formation unit configured to form a first optical image corresponding to the first picture and a second optical image corresponding to the second picture, and
a projection unit configured to project the first optical image and the second optical image formed by the optical image formation unit onto a projection object.

10. The picture presentation system according to claim 8, wherein the picture presentation unit includes a display unit configured to display the first picture and the second picture.

11. A picture presentation system comprising:
a shutter device that includes:
a shutter,
a receiving unit configured to receive a control signal used to control opening/closing of the shutter, and
a control unit configured to control opening/closing of the shutter on the basis of the control signal; and
a picture presentation device that includes:
a picture presentation unit configured to alternately present a residual picture based on residual picture data obtained by subtracting second picture data from first picture data and a second picture based on the second picture data, and
a transmitting unit configured to transmit the control signal to i) bring the shutter into a closed state when the residual picture is presented, and ii) bring the shutter into an opened state when the second picture is presented.

12. The picture presentation system according to claim 11, wherein the picture presentation unit includes:
an optical image formation unit configured to form a second optical image corresponding to the second picture data and a residual optical image corresponding to the residual picture data, and
a projection unit configured to project the second optical image and the residual optical image formed by the optical image formation unit onto a projection object.

13. The picture presentation system according to claim 11, wherein the picture presentation unit includes a display unit configured to display the second picture and the residual picture.

14. The picture presentation system according to claim 11, further comprising a generation unit configured to generate the residual picture data obtained by subtracting the second picture data from the first picture data.

15. A picture presentation system comprising:
a picture presentation device that includes:
a first polarizing filter configured to convert transmitted light into first linearly polarized light or left-handed circularly polarized light with a first polarizing axis,
a second polarizing filter configured to convert transmitted light into second linearly polarized light or right-handed circularly polarized light with a second polarizing axis intersecting the first polarizing axis at right angles, and
a picture presentation unit configured to present i) a residual picture transmitted through the first polarizing filter and based on residual picture data obtained by subtracting second picture data from first picture data, and ii) a second picture transmitted through the second polarizing filter and based on the second picture data; and
a filter device that includes a third polarizing filter configured to selectively present the second picture.

16. The picture presentation system according to claim 15, wherein the picture presentation unit includes:
an optical image formation unit configured to form a second optical image corresponding to the second picture data and a residual optical image corresponding to the residual picture data, and
a projection unit configured to project the second optical image onto a projection object through the first polarizing filter, and project the residual optical image onto the projection object through the second polarizing filter, the second optical image and the residual optical image being formed by the optical image formation unit.
